(19) United States
(12) Patent Application Publication
(10) Pub. No.: US 2016/0228894 A1
(43) Pub. Date: Aug. 11, 2016

(54) INSULATING ELECTRIFICATION PLATE FERRITE APPLICATOR FOR A DIPOLE LIGHTNING ROD

(71) Applicant: Young-ki Chung, Seoul (KR)

(72) Inventor: Young-ki Chung, Seoul (KR)

(21) Appl. No.: 14/662,283

(22) Filed: Mar. 19, 2015

(30) Foreign Application Priority Data
Feb. 6, 2015 (KR) 10-2015-0018674

(51) Int. Cl. B05B 7/00; B05B 13/02; B05B 12/02; H02G 13/00

(52) U.S. Cl. CPC B05B 7/0075; H02G 13/80; B05B 13/0228; B05B 12/02

(57) ABSTRACT

Disclosed herein is an insulating electrification plate ferrite applicator for a dipole lightning rod. The ferrite applicator may include a compression air generation unit configured to generate and charge compressed air, a storage tank connected to the compression air generation unit and configured to stored a ferrite coating material, an applicator body equipped with a turntable configured to rotatably support an electrification plate and an operation control unit, a spray nozzle unit installed on top of the applicator body and configured to spray and supply the ferrite coating material, and a location tracking unit configured to guide the spray nozzle unit so that the spray nozzle unit performs a straight-line reciprocating motion horizontally and vertically. Accordingly, there are advantages in that a ferrite coating task for lowering a corona pre-discharge current and a corona preliminary discharge voltage can be automated and uniformly performed and the reliability and productivity of a task can be significantly improved.

### CROSS REFERENCE TO RELATED APPLICATION

The present application claims the benefit of Korean Patent Application No. 10-2015-0018674 filed in the Korean Intellectual Property Office on Feb. 6, 2015, the entire contents of which are incorporated herein by reference.

### BACKGROUND OF THE INVENTION

1. Technical Field

The present invention relates to an insulating electrification plate ferrite applicator for a dipole lightning rod and, more particularly, to an insulating electrification plate ferrite applicator for a dipole lightning rod, wherein a ferrite coating layer for increasing a corona pre-discharge current and lowering a corona discharge starting voltage with respect to a specific element forming the dipole lightning rod is formed.

2. Description of the Related Art

In general, a lightning protection device is installed at the top of a building in order to safely discharge charges, accumulated on a thundercloud, to the earth by forming a discharge path between the thundercloud and the earth.

A conventional dipole lightning protection device is described below with reference to FIG. 1.

As illustrated in FIG. 1, the conventional dipole lightning protection device includes a fixing unit 31 installed at the top of a building and connected to earth means, a rod 30 configured to have one end fixed to the fixing unit 31 electrically charged by the charges of the earth, a rod cap 32 coupled with the other end of the rod 30 and configured to guide the falling of a thunderbolt, an insulator 34 and metallic electrification plates 37 and 38 coupled with one side of the rod 30 in the length direction thereof, and electrification means 45 disposed under the electrification plates 37 and 38. The rod 30 is embedded at the center of an electrification tube 45a.

The electrification means 45 includes the electrification tube 45a configured to have a tubular shape, have the rod 30 penetrate the center of the electrification tube 45a, and have a needle-shaped tip 45b formed on the part of the rod 30 and a first cap 45c and a second cap 45d configured to couple both ends of the electrification tube 45a with the rod 30. The second cap 45d is closely fixed to the insulator 34 by a stopper 46.

A dipole lightning protection device, such as that illustrated in FIG. 1, is disclosed in Korean Patent No. 0856719 that was invented by Jung Yong-ki who is the same inventor as that of the present invention.

However, the conventional dipole lightning protection device configured as described above is problematic in that a preliminary discharge corona discharge start voltage is irregularly generated between the electrification plates 37 and 38 (also called “discharge-assistant members”) electrically charges when a thundercloud approaches and the rod 30 connected to charges accumulated on the electrification tube 45a and the earth.

In particular, it was found that the conventional dipole lightning protection device is limited in increasing a preliminary discharge current after the preliminary discharge start.
Accordingly, the inventor has developed a plurality of technologies related to the dipole lightning protection device and had some patent rights regarding the dipole lightning protection device. In a process of developing various structures for rapidly discharging charges accumulated on a thundercloud to the earth after a preliminary discharge is started in a lightning protection device using a dipole, the inventor has published that the effect of “a magnetic field on the start voltage and current of a corona discharge is based on a cyclone motion according to a Lorentz force” through a collection of papers called “The effect of the magnetic fields on the corona discharge” in the Korean Institute of Illuminating and Electrical Installation Engineers Thesis Vol. 15 No. 3 (published on May 2001, a writer Jae-yun Park including 2 persons). Furthermore, the inventor has discovered that a magnetic field affects a corona discharge through “Analysis of the electromagnetic phenomena in vacuum interrupter with axial magnetic field type, Journal of the Korean Institute of Electrical and Electronic Material Engineers Vol. 16. 2003. 10. 10” to which a technology for extinguishing an arc generated between electrodes from which a corona discharge is generated when magnetic fields are applied between the electrodes has been applied. Furthermore, the inventor discovered that a magnetic field is generated when the falling of a thunderbolt is introduced into a flat plate through “Certification of aircraft system and avionics equipment against lightning indirect effect” (Aerospace Engineering and Technology Vol. 4 No. 1, Sang-ho Han).

Furthermore, the inventor has discovered that phenomenon is generated in which assuming that the size of an electrical dipole according to an electric dual layer between electrification electrodes having a dielectric interposed therebetween is “d” and a dipole moment is P(t)=q(t)d, a current considers a dipole having a current of I=q=p/d to be as a pair of dot charges and thus flows from one dot charge to the other dot charge.

Under the aforementioned theoretical backgrounds, the inventor has discovered that in such a magnetic field and dielectric, an electric dipole generated by the electric dual layer is one of factors that affect the corona preliminary discharge generated in the dipole lightning rod when a thundercloud approaches. In order to increase the corona pre-discharge current and lower the corona discharge voltage in the dipole lightning protection devices invented by and issued to the inventor, the inventor has developed and manufactured a coating layer or film made of magnetic material powder having a dielectric property and binder resin, such as epoxy. Accordingly, the inventor has discovered through several hundreds of experiments that if the coating layer is coated on the electrostatic induction body (e.g., the electrification plate or the electrification tube or both) of the dipole lightning protection device or a film layer is formed using the coating layer, the corona pre-discharge current and the corona preliminary discharge voltage are reduced. Accordingly, there is a need for an apparatus capable of uniformly automating a coating task for the electrostatic induction body.

### PRIOR ART DOCUMENT

### Patent Document

Korean Patent No. 0856719 (Aug. 29, 2008)

### SUMMARY OF THE INVENTION

Accordingly, the present invention has been made keeping in mind the above problems occurring in the prior art, and an object of the present invention is to provide an insulating electrification plate ferrite applicator for a dipole lightning rod, wherein a ferrite coating layer for increasing a corona pre-discharge current and lowering a corona discharge starting voltage with respect to a specific element forming the dipole lightning rod is formed.

In an embodiment, an insulating electrification plate ferrite applicator for a dipole lightning rod includes a compression air generation unit configured to generate and charge compressed air, a storage tank connected to the compression air generation unit and configured to store a ferrite coating material, an applicator body equipped with a turntable configured to rotatably support an electrification plate and an operation control unit, a spray nozzle unit installed on top of the applicator body and configured to spray and supply the ferrite coating material, and a location tracking unit configured to guide the spray nozzle unit so that the spray nozzle unit performs a straight-line reciprocating motion horizontally and vertically.

The spray nozzle unit may include a nozzle body configured to have spray units formed at the bottom of the nozzle body, injection valves installed on both sides of the nozzle body and configured to have the ferrite coating material injected into the injection valves, and an injection control unit installed in the nozzle body and configured to control the amount of injection and spray intensity of an injected ferrite coating material.

The location tracking unit may include an elevation movement member installed in the rear of the spray nozzle unit and configured to move the spray nozzle unit up and down, a horizontal movement member installed in the rear of the elevation movement member and configured to horizontally move the elevation movement member in a straight line, and a fixing support post configured to support the horizontal movement member.

A driving motor may be installed at one end of each of the elevation movement member and the horizontal movement member.

When the applicator body is viewed at the front, the turntable may be installed on top of the applicator body on one side of the applicator body, and the spray nozzle unit may be placed at the center of the applicator body.

The storage tank may include a first tank and second tank which are separately configured and in which the ferrite coating material is formed of a mixture of powder and a resin material.

The operation control unit may include a power switch, a plurality of switches for manipulating operation mode, an emergency stop, and valve control mode, and a monitor for displaying the operating state of the switches.

The ferrite applicator may further include a press for pressurization installed at a location spaced apart from the applicator body at a specific interval and configured to pressurize two electrification plates that overlap with each other in a surface contact state in an integrated structure. In this case, the ferrite coating material is interposed between the two electrification plates.

### BRIEF DESCRIPTION OF THE DRAWINGS

FIG. 1 is a perspective view illustrating the configuration of a conventional dipole lightning protection device;

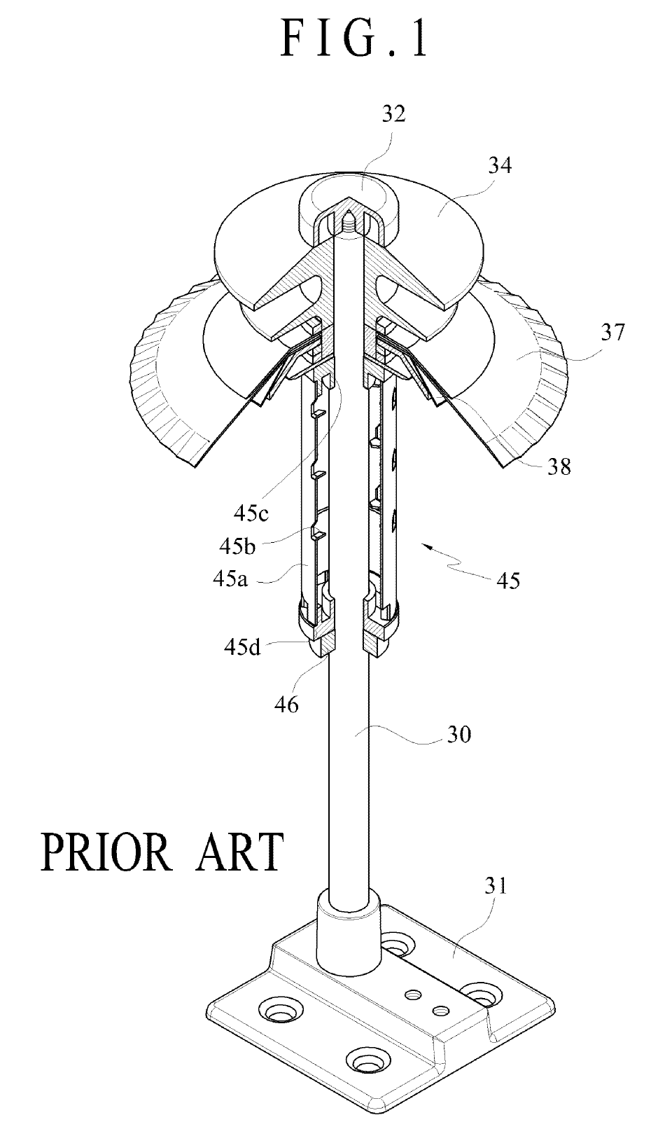

FIG. 2 is a perspective view of an insulating electrification plate ferrite applicator for a dipole lightning rod according to an embodiment of the present invention;

FIG. 3 is a front view of the insulating electrification plate ferrite applicator of FIG. 2;

FIG. 4 is a front view of a partial enlarged view illustrating a press for pressurization illustrated in FIG. 2;

FIG. 5 a partial enlarged view illustrating the configuration of a spray nozzle unit and location tracking unit of FIG. 2;

FIG. 6 is a front view illustrating the action of the location tracking unit of FIG. 2; and

FIG. 7 is a front view illustrating the action of the spray nozzle unit of FIG. 2.

### DESCRIPTION OF REFERENCE NUMERALS

| 100: compression air generation unit | |
|---|---|
| 200: storage tank | 210: first tank |
| 220: second tank | 300: applicator body |
| 310: turntable | 320: operation control unit |
| 400: spray nozzle unit | 500: location tracking unit |
| 600: press for pressurization | 700: shelf frame |

11, 12: electrification plate

### DETAILED DESCRIPTION

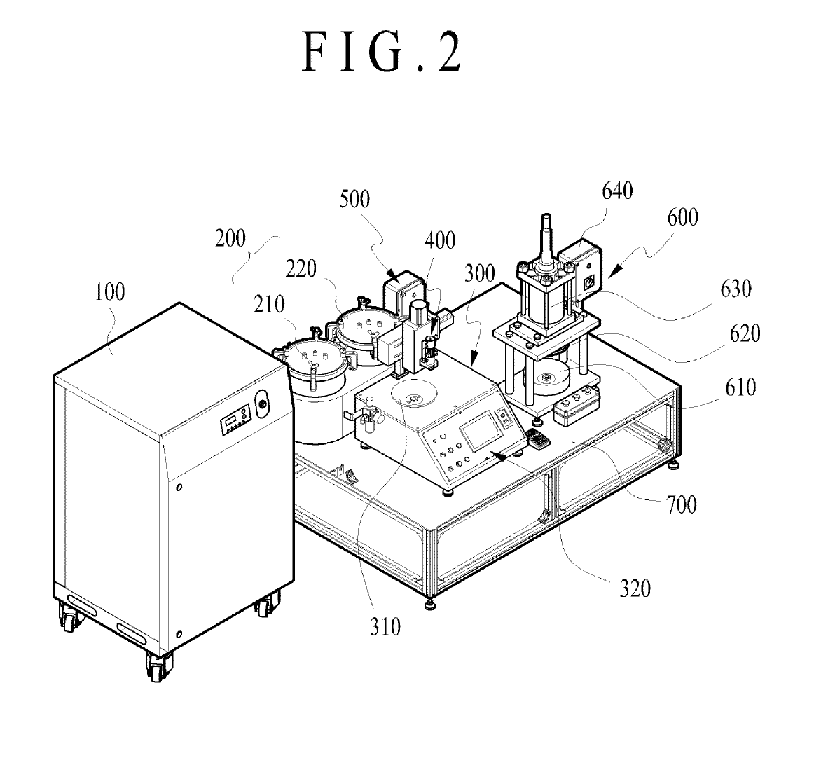

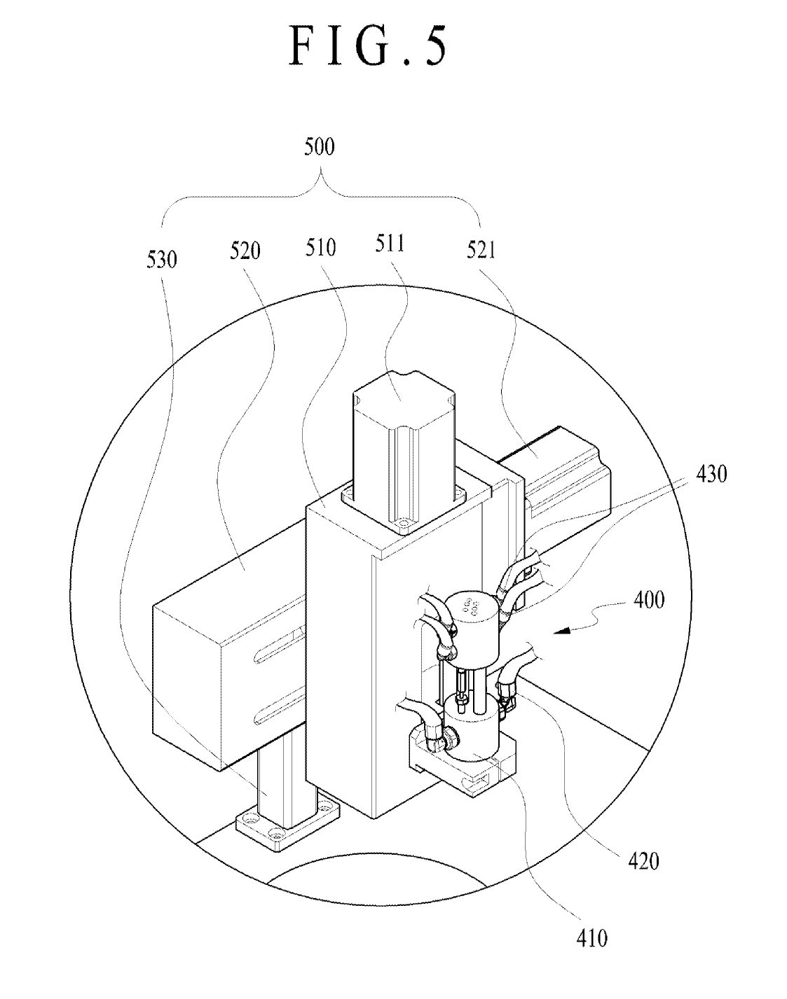

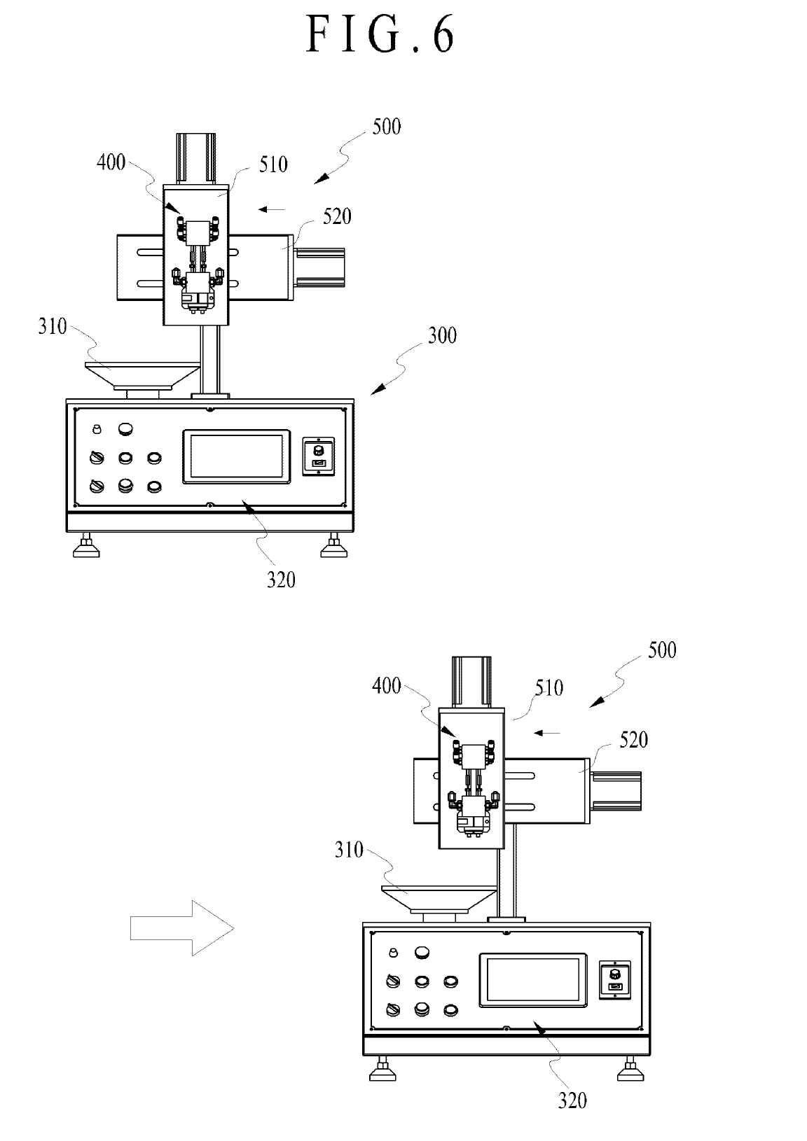

Hereinafter, embodiments of the present invention are described in detail with reference to FIGS. 2 to 7.

Prior to a description, in the present invention, a term “coating” should be construed as including all of terms “cladding”, “stacking”, and “adhesion” which are collectively called “coating”, for convenience of description. A layer formed by “coating”, “cladding”, “stacking”, or “adhesion” is called a “coating layer.”

As illustrated in FIGS. 2 to 7, the insulating electrification plate ferrite applicator for a dipole lightning rod according to an embodiment of the present invention is used to previously coat a ferrite coating material on a metal electrification plate 11 before two metal electrification plates 11 and 12 of elements that form the dipole lightning rod are coalesced. The ferrite applicator may be configured to include a compression air generation unit 100 configured to generate and charge compressed air, a storage tank 200 connected to the compression air generation unit 100 and configured to store a ferrite coating material, an applicator body 300 equipped with a turntable 310 for rotatably supporting the electrification plate 11 and an operation control unit 320, a spray nozzle unit 400 installed on top of the applicator body 300 and configured to spray and supply the ferrite coating material, and a location tracking unit 500 configured to guide the spray nozzle unit 400 so that it performs a straight-line reciprocating motion horizontally and vertically.

First, the compression air generation unit 100 generates compressed air using an externally electrified current. The generated compressed air is used to drive an apparatus using a force of pressure.

The compression air generation unit 100 may be configured to have a box-shaped cabinet structure having a specific size. The cabinet may include a compressor (not illustrated) for compressing air, an air storage unit (not illustrated) for storing the compressed air, and a pressure check valve (not illustrated) for checking a change of pressure within the air storage unit in real time.

The storage tank 200 is connected to the compression air generation unit 100, and functions to store a ferrite coating material.

The storage tank 200 may include a first tank 210 and a second tank 220 for storing the ferrite coating material in a mixed state of powder and a resin material.

More specifically, in the first tank 210, ferrite powder, that is, magnetic material powder that has a particle size of 0.95 μm and includes Fe2O3, Ni, and Zn as major components wherein Fe2O3, Ni, Zn, and other impurities respectively have optimal composition ratios of 90 wt %, 8 wt %, 1 wt %, and 1 wt %, general-purpose epoxy resin for a binder, and methyl ethyl ketone (MEK), that is, a solvent, are sufficiently agitated for 20 minutes, thereby manufacturing a first coating solution.

When the first coating solution is manufactured, in the mixture ratio of the general-purpose epoxy resin, the ferrite powder, and MEK, the general-purpose epoxy resin is 22.7 wt %, the ferrite powder is 68.2 wt %, and MEK is 9.1 wt %.

Furthermore, in the second tank 220, ferrite powder, that is, magnetic material powder that has a particle size of 0.95 and includes Fe2O3, Ni, and Zn as major components wherein Fe2O3, Ni, Zn, and other impurities respectively have composition ratios of 90 wt %, 8 wt %, 1 wt %, and 1 wt %, bisphenol A type epoxy resin, and methyl ethyl ketone (MEK) are sufficiently agitated for 20 minutes, thereby manufacturing a second coating solution

When the second coating solution is manufactured, in the mixture ratio of the bisphenol A type epoxy resin, the ferrite powder, and MEK, the general-purpose epoxy resin is 22.7 wt %, the ferrite powder is 68.2 wt %, and MEK is 9.1 wt %.

The storage tank 200 according to an embodiment of the present invention has been illustrated as including the first tank 210 and the second tank 220 that are separately configured, and the first coating solution and the second coating solution have been illustrated as being manufactured with different composition ratios. This is for efficiency of a ferrite coating layer work, but the present invention is not necessarily limited thereto. For example, only one of the first coating solution and the second coating solution may be selected and used.

The ferrite coating material stored in the storage tank 200 is supplied to the spray nozzle unit 400 by air pressure supplied by the compression air generation unit 100.

The applicator body 300 is a work structure for forming a ferrite coating layer with respect to the metal electrification plate 11 of the dipole lightning rod. The turntable 310 for rotatably supporting the electrification plate 11 and the spray nozzle unit 400 are installed on top of the applicator body 300. The operation control unit 320 for controlling the operations of the elements is formed on the front of the applicator body 300.

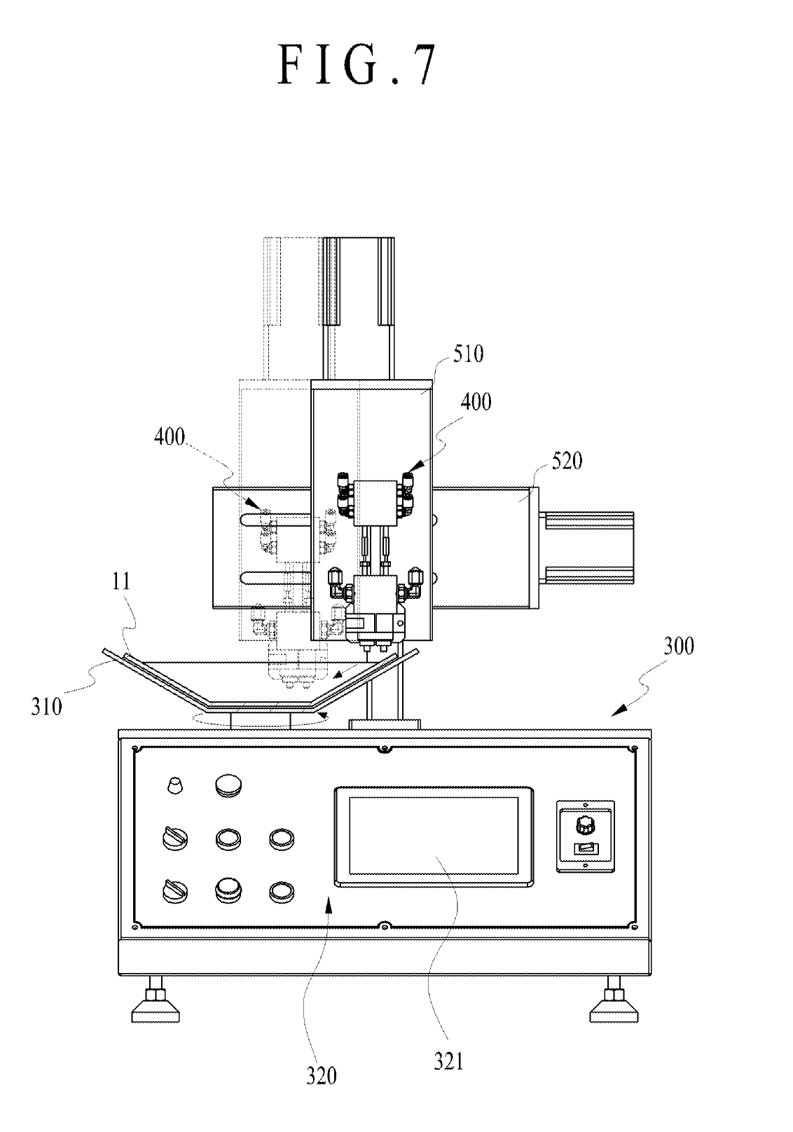

The turntable 310 is a structure corresponding to the formation of the electrification plate 11 and is rotated by a motor (not illustrated) installed within the applicator body 300 (refer to FIG. 7)

That is, when the electrification plate 11 is placed on the turntable 310, the turntable 310 rotates at constant rotating speed. In this case, while the spray nozzle unit 400 installed over the turntable 310 moves, it sprays the ferrite coating material so that a coating layer is formed on the entire circumference of the electrification plate 11 in the circumferential direction thereof.

Furthermore, when the applicator body 300 is viewed at the front, the turntable 310 may be installed on top of the applicator body 300 on one side thereof, and the spray nozzle unit 400 may be placed at the center of the applicator body 300.

The reason for this is to prevent a defective product and damage to devices attributable to an impact of a collision between the electrification plate 11 and the spray nozzle unit 400 that is generated when the electrification plate 11 approaches the spray nozzle unit 400 in a process of placing the electrification plate 11 on the turntable 310 or detaching the electrification plate 11 from the turntable 310 if the turntable 310 and the spray nozzle unit 400 are placed in the same line.

The operation control unit 320 may be configured to include power switch, a plurality of switches for manipulating operation mode, an emergency stop, and valve control mode, and a monitor 321 for displaying the operating state of the switches.

Furthermore, the ferrite applicator may further include a press for pressurization 600 placed at a location spaced apart from the applicator body 300 at a specific interval and configured to pressurize specific electrification plate 12 using constant pressure in the state in which the specific electrification plate 12 has been placed on the ferrite coating material coated on the electrification plate 11.

That is, the press for pressurization 600 is installed at a location spaced apart from the applicator body 300 at a specific interval. The press for pressurization 600 pressurizes the two electrification plates 11 and 12, overlapping with each other in a surface contact state, in an integrated structure. In this case, the ferrite coating material is interposed between the two electrification plates 11 and 12.

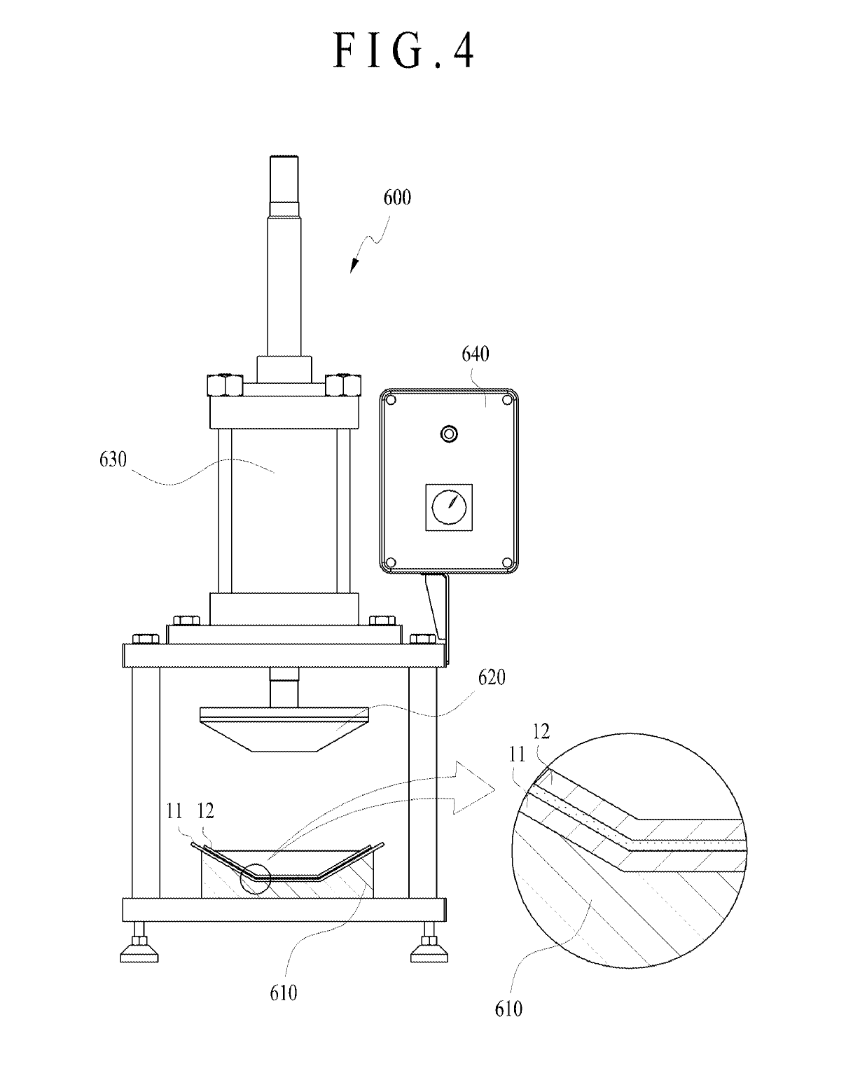

As illustrated in FIG. 4, the press for pressurization 600 may include a table 610 configured to support the electrification plates 11 and 12, an upper mold 620 disposed over the table 610, a cylinder rod 630 configured to move the upper mold 620 up and down using constant pressure, and an operation switch 640 configured to drive the cylinder rod 630.

The cylinder rod 630 is driven by pressure supplied by the compression air generation unit 100.

The ferrite applicator may be configured to further include a shelf frame 700 for supporting the applicator body 300 and the press for pressurization 600 as illustrated in FIG. 2.

The spray nozzle unit 400 is disposed on top of the applicator body 300, and functions to spray the ferrite coating material from the storage tank 200 on the electrification plate 11.

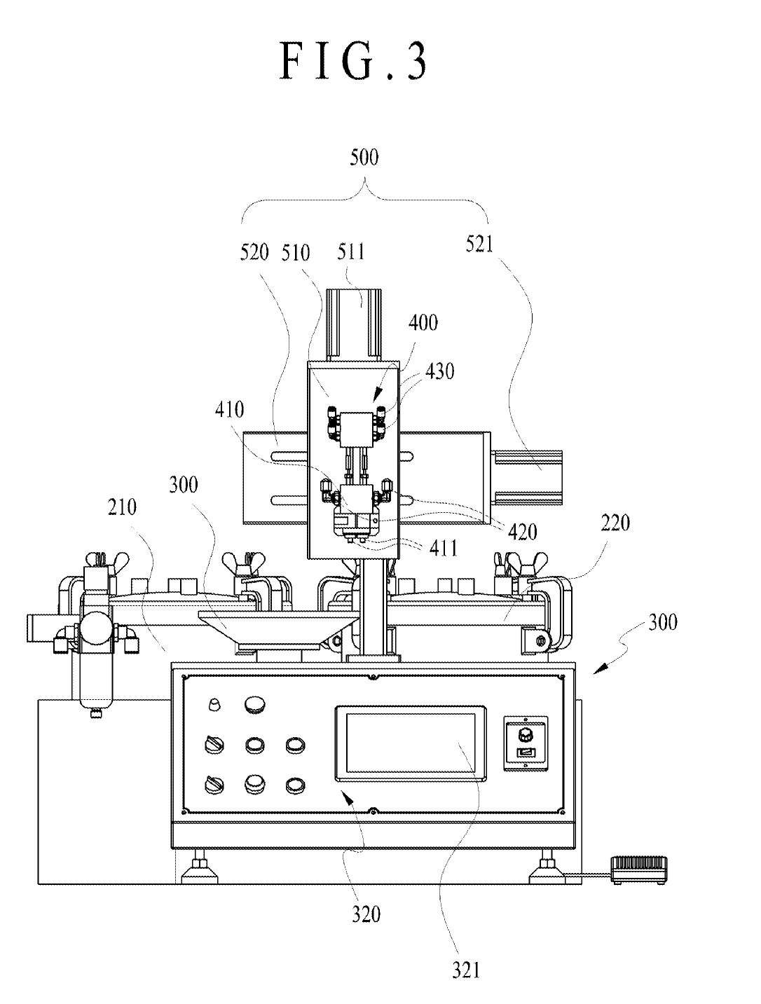

As illustrated in FIG. 3, the spray nozzle unit 400 may include a nozzle body 410 configured to have spray units 411 formed at the bottom thereof, injection valves 420 disposed in the ends of the nozzle body 410 on both sides thereof and configured to have the ferrite coating material injected therein, and an injection control unit 430 installed in the nozzle body 410 and configured to control the amount of injection and spray intensity of an injected ferrite coating material.

That is, when the ferrite coating material is injected into the nozzle body 410 through the injection valves 420, the injection control unit 430 operates and controls the amount of injection and spray intensity of the ferrite coating material in accordance with the size of the electrification plate 11. The ferrite coating material controlled as described above is discharged with constant pressure through the spray units 411 of the nozzle body 410.

The injection control unit 430 also performs its control action by pressure supplied by the compression air generation unit 100.

Furthermore, the location tracking unit 500 is disposed in the rear of the spray nozzle unit 400, and functions to guide the spray nozzle unit 400 so that it performs a straight-line reciprocating motion horizontally and vertically.

That is, the location tracking unit 500 moves the spray nozzle unit 400 to the turntable 310 that supports the electrification plate 11 and also moves the spray nozzle unit 400 downward from the location, spaced apart from the electrification plate 11 at a specific height, in the tilt direction of the electrification plate 11.

More specifically, the location tracking unit 500 may be configured to include an elevation movement member 510 disposed in the rear of the spray nozzle unit 400 and configured to move the spray nozzle unit 400 up and down, a horizontal movement member 520 disposed in the rear of the elevation movement member 510 and configured to horizontally move the elevation movement member 510 in a straight line, and a fixing support post 530 configured to support the horizontal movement member 520.

Furthermore, driving motors 511 and 521 are respectively installed at the ends of the elevation movement member 510 and the horizontal movement member 520.

That is, the driving motor 521 installed in the horizontal movement member 520 functions to horizontally move the elevation movement member 510 in a straight line. The driving motor 511 installed in the elevation movement member 510 functions to move the spray nozzle unit 400 up and down in a straight line.

As described above, the ferrite applicator according to an embodiment of the present invention includes the applicator body 300 equipped with the turntable 310, the spray nozzle unit configured to guide the ferrite coating material so that it is sprayed on the electrification plate 11, and the location tracking unit. Accordingly, there are advantages in that a ferrite coating task for increasing a corona pre-discharge current and lowering a corona preliminary discharge voltage can be automated and uniformly performed and the reliability and productivity of a task can be significantly improved.

What is claimed is:

1. An insulating electrification plate ferrite applicator for a dipole lightning rod, the ferrite applicator comprising:
a compression air generation unit configured to generate and charge compressed air;
a storage tank connected to the compression air generation unit and configured to store a ferrite coating material;
an applicator body equipped with a turntable configured to rotatably support an electrification plate and an operation control unit;
a spray nozzle unit installed on top of the applicator body and configured to spray and supply the ferrite coating material; and
a location tracking unit configured to guide the spray nozzle unit so that the spray nozzle unit performs a straight-line reciprocating motion horizontally and vertically.

2. The ferrite applicator of claim 1, wherein the spray nozzle unit comprises:
a nozzle body configured to have spray units formed at a bottom of the nozzle body,
injection valves installed on both sides of the nozzle body and configured to have the ferrite coating material injected into the injection valves, and
an injection control unit installed in the nozzle body and configured to control an amount of injection and spray intensity of an injected ferrite coating material.

3. The ferrite applicator of claim 2, wherein the location tracking unit comprises:
an elevation movement member installed in a rear of the spray nozzle unit and configured to move the spray nozzle unit up and down,
a horizontal movement member installed in a rear of the elevation movement member and configured to horizontally move the elevation movement member in a straight line, and
a fixing support post configured to support the horizontal movement member.

4. The ferrite applicator of claim 3, wherein a driving motor is installed at one end of each of the elevation movement member and the horizontal movement member.

5. The ferrite applicator of claim 2, wherein when the applicator body is viewed at a front, the turntable is installed on top of the applicator body on one side of the applicator body, and the spray nozzle unit is placed at a center of the applicator body.

6. The ferrite applicator of claims 1, wherein the storage tank comprises a first tank and second tank which are separately configured and in which the ferrite coating material is formed of a mixture of powder and a resin material.

7. The ferrite applicator of claim 6, wherein the operation control unit comprises a power switch, a plurality of switches for manipulating operation mode, an emergency stop, and valve control mode, and a monitor for displaying an operating state of the switches.

8. The ferrite applicator of claim 7, further comprising a press for pressurization installed at a location spaced apart from the applicator body at a specific interval and configured to pressurize two electrification plates that overlap with each other in a surface contact state in an integrated structure, wherein the ferrite coating material is interposed between the two electrification plates.
